(19) United States
(12) Patent Application Publication
(10) Pub. No.: US 2013/0182601 A1
(43) Pub. Date: Jul. 18, 2013

(54) System and Method for Aggregating and Estimating the Bandwidth of Multiple Network Interfaces

(71) Applicants: Soma Bandyopadhyay, Kolkata (IN); Shameemraj M. Nadaf, Kolkata (IN)

(72) Inventors: Soma Bandyopadhyay, Kolkata (IN); Shameemraj M. Nadaf, Kolkata (IN)

(21) Appl. No.: 13/876,550

(22) PCT Filed: Dec. 7, 2011
(86) PCT No.: PCT/IN11/00838

§ 371 Date: Mar. 28, 2013

(30) Foreign Application Priority Data
Feb. 2, 2011 (IN) 299/MUM/2011

(51) Int. Cl. H04L 12/24

(52) U.S. Cl. CPC H04L 41/0896
USPC 370/252; 370/389; 370/392

(57) ABSTRACT

The present invention provides a system and method for aggregating and estimating the bandwidth of the multiple network interfaces. Particularly, the invention provides a cross layer system for bandwidth aggregation based on dynamic analysis of network conditions. Further, the invention provides a system and method of estimation for evaluating bandwidth of multiple physical interfaces.

### FIELD OF THE INVENTION

The present invention relates to the field of telecommunication. Particularly, the invention relates to a cross layer system for bandwidth aggregation and estimation further based on dynamic analysis of network conditions. More particularly, the invention provides a system and method that estimates bandwidth of multiple physical interfaces and distributes it further to such multiple physical interfaces.

### PRIOR ART REFERENCES

1) K. Chebrolu and R. R. Rao, “Bandwidth aggregation for real-time applications in heterogeneous wireless networks,” IEEE Transactions on Mobile Computing, vol. 5, no. 4, pp. 388-403, 2006.
2) Evensen, K.; Kaspar, D.; Engelstad, P.; Hansen, A. F.; Griwodz, C.; Halvorsen, P.; Simula Res. Lab., Lysaker, Norway “A network-layer proxy for bandwidth aggregation and reduction of IP packet reordering” in Local Computer Networks, 2009; http://simula.no/research/nd/publications/Simula.ND.369/simula_pdf file.
3) K. Chebrolu, B. Raman, and R. R. Rao, “A network layer approach to enable TCP over multiple interfaces,” Wireless Networks, vol. 11, no. 5, pp. 637-650, 2005.
4) Juan Carlos Fernandez, Tarik Taleb, Mohsen Guizani, Nei Kato-Bandwidth Aggregation-Aware Dynamic QoS Negotiation for Real-Time Video Streaming in Next-Generation Wireless Networks, IEEE transactions on multimedia, Vol. 11, No. 6, October 2009.
5) A. Habib, N. Christin, and J. Chuang, “Taking advantage of multihoming with session layer striping,” in INFOCOM, 2006 http://www.andrew.cmu.edu/user/nicolasc/publications/gistripping.pdf
6) Horde: Flexible Application Driven Network Striping http://publications.csail.mitedu/abstracts/abstracts05/horde/horde.html
7) Cross Layer Design of Ad-hoc Wireless Networks for Real-Time Media http://www.stanford.edu/˜zhuxq/adhoc_project/adhoc_project.html
8) T. Taleb, K. Kashibuchi, A. Leonardi, S. Palazzo, K. Hashimoto, N. Kato, and Y. Nemoto, “A cross-layer approach for an efficient delivery of TCP/RTP-based multimedia applications in heterogeneous wireless networks,” IEEE Trans. Veh. Technol., vol. 57, no. 6, pp. 3801-3814, November 2008.
9) T. Taleb, T. Nakamura, and K. Hashimoto Bandwidth aggregation-aware dynamic Qos negotiation for real-time video streaming in next-generation wireless networks IEEE TRANSACTIONS ON MULTIMEDIA, VOL. 11, NO. 6, OCTOBER 2009
10) H. Adiseshu, G. Parulkar, and G. Varghese, “A reliable and scalable striping protocol,” ACM SIGCOMM, 1996.
11) A. C. Snoeren, “Adaptive inverse multiplexing for wide-area wireless networks,” in GLOBECOM, 1999.
12) J. Chesterfield, R. Chakravorty, I. Pratt, S. Banerjee, and P. Rodriguez, “Exploiting diversity to enhance multimedia streaming over cellular links,” in INFOCOM, March 2005.
13) S. Shakkottai, E. Altman, and A. Kumar, “The case for non-cooperative multihoming of users to access points in IEEE 802.11 WLANs,” in INFOCOM, 2006.
14) James Curtis, Tony McGregor “Review of Bandwidth Estimation Techniques” http://citeseerx.ist.psu.edu/viewdoc/summary?doi=10.1.1.29.779
15) Mayukh Saubhasik, Uwe Schmidt “Bandwidth Estimation and Rate Control in Bit Vampire” CPSC 527: Advanced Computer Networks. www.uweschmidt.org/files/network_project.pdf
16) Jiri Navratil and R. Les. Cottrell “ABwE: A Practical Approach to Available Bandwidth Estimation” http://www.nlanr.net/PAM2003/PAM2003papers/3781.pdf
17) T. G. Sultanov, A. M. Sukhov “Simulation technique for available bandwidth estimation” http://arxiv.org/PS_cache/arxiv/pdf/1007/1007.3341v1.pdf

### BACKGROUND OF THE INVENTION

Data transfer through multiple physical interfaces is widely studied for improving the total available bandwidth for network based applications. Most of the related work in this area requires proxy architecture, service level agreement and counter component at the destination, to realize the bandwidth aggregation either in adaptive and non-adaptive manners. Some of the prior arts known to us will now be discussed to understand the available technical solutions and shortcomings in the state of the art.

A network layer architecture consisting of an infrastructure proxy as mentioned reference number #1 of the prior art references or a multilink proxy as mentioned reference number #2 of the prior art references is used for simultaneous use of multiple interfaces and aggregation of the throughput of heterogeneous downlink streams.

The approach suggested in reference number #3 of the prior art references, uses a dynamic packet reordering mechanism of TCP streams over multiple links; also it requires a network proxy. Service level agreement as well as proxy is used in the middle of the network for scheduling the packets through multiple interfaces as mentioned in reference number #4.

Architecture for session-layer striping over multiple links is proposed in reference number #5 which is based on single virtual layer socket. Furthermore reference number #6, describes a network middleware called Horde, which enables applications to control certain aspects of data stripping over multiple interfaces. It is further disclosed that this middleware architecture comprises 3 layers in which the higher layer provides an interface to interact with Horde; middle layer handles packet scheduling, bandwidth allocation, and the lower layer deals with network channels.

The cross layer framework as mentioned in prior art reference number #7 proposes adaptation across many layers of the protocol stack to support delay-critical applications in adhoc scenario, such as conversational voice or real-time video.

The work presented in prior art reference number #8 proposes to make changes to the five layers namely physical, data link, application, network, and transport layer like TCP to provide seamless delivery of multimedia services in heterogeneous wireless networks. Some modifications have been made to the Transport protocols that eventually make deployment of such an approach as difficult as it needs a corresponding component at the destination.

Prior art reference number #8 discloses a dynamic QoS negotiation scheme for enabling bandwidth aggregation for video streaming in wireless networks. It is disclosed that multiple interfaces of the same technology can be striped for better performance at the link layer, which is referred to as bonding or trunking. Prior art reference number #10 discloses a method of bandwidth aggregation on the link layer by striping data across bundle of physical channels.

An adaptive inverse multiplexing technique has been disclosed in prior art reference number #11 where IP Packets are fragmented by the multiplexor and tunneled through multiple links using ML PPP (multi link ppp) over a link layer transfer protocol.

A method for channel aggregation in cellular networks is disclosed in prior art reference number #12. The reference suggests that in order to improve resilience, parity codes are applied across channels rather than across packets.

Another interesting approach is followed in prior art reference number #13, where it is proposed that users of WLANs should be able to multihome and split their traffic among all available access points, based on obtained throughput and a charged price. However, a link-layer solution of striping data through heterogeneous networks and to different IP addresses is not feasible because the link layer has no notion of IP.

U.S. Pat. No. 6,810,412 by Chang, et al. teaches a communication network having a server which communicates with a switch using a high bandwidth connection. The said prior art discloses a network interface which needs counter components (Client server based architecture), and server using a single interface. It requires an intermediate switch/network proxy architecture which is responsible for distribution of the data traffic among the client and server. It does not perform any network estimation while performing the bandwidth aggregation.

U.S. Pat. No. 7,460,526 by Hoffman et al. teaches a system and method for establishing an inverse multiplexed connection using layer one resources dedicated to a carrier virtual network. The said prior art discloses a system and method which requires a service level agreement to perform the aggregation, based on network demands and needs specific network architecture—example network management system. It also establishes a carrier virtual network and works with three different telecommunication networks and an aggregator. The aggregation is done by the network manager.

It is submitted that, all the approaches described above demand modifications at both ends (i.e. server and client) to achieve bandwidth aggregation and most of the approaches are tested in simulations, often based on very simple assumptions.

Further Bandwidth estimation of the network in real-time is also an appealing problem and has attracted quite a few research works. Most of the works in this area are based on RTT (round-trip-time) measurement, using a single or multiple probe packets. Theory, improvements and some implementations related to Bandwidth estimation techniques based on RTT mechanism have been discussed as mentioned in prior art reference number #14. UDP based probe packet mechanism is used to measure the bandwidth estimation and rate control in a P2P (peer-to-peer) based video streaming application as mentioned in prior art reference number #15. The available bandwidth is calculated depending on the determined RTT values the upload bit rates. The estimated bandwidth determines whether to accept or reject a new P2P client requesting a connection at a random data rate. This method results in unstable RTT measurements since set of peers may be located anywhere in the world.

Prior art reference number #16 discloses, use of pair of probe packets with a fixed delay and packet pair dispersion technique is used to measure the available bandwidth. Along with the RTT calculation the time delay between the probe packets is measured and analyzed to predict the network bandwidth.

A variable size probe packet can also be used to measure the available bandwidths as disclosed in prior art reference number #17. Along with RTT the packet size is also used in this case to estimate the network capacity. Here a testing network including a test box measurement infrastructure is used.

U.S. Pat. No. 7,505,401 by Kashyap et al. teaches a method, apparatus and program storage device for providing mutual failover and load-balancing between interfaces in a network is disclosed. The said prior art provides method for network connections for mutual failover and load sharing using multiple interfaces, one interface used as a backup of another interface. It uses multiple virtual interfaces. It does not perform any estimation of bandwidth while performing the load sharing.

Some of the lacunae that exists in the prior art discussed above are that, firstly these research efforts are based on single or multiple interfaces and need counterpart in the destination; secondly the prior arts have not used multiple interfaces simultaneously to perform the bandwidth estimation. These approaches also do not make use of any cross layer technique.

Thus there exists a need to solve the long standing problem of bandwidth aggregation without using any corresponding component at the final destination or at any node, or a particular network architecture, or using any network proxy or management node and also without performing any modifications in the physical and data link layers and also estimating bandwidth of multiple physical interfaces.

### OBJECTIVES OF THE INVENTION

The primary objective of the invention is to provide a cross layer system which can perform bandwidth aggregation based on dynamic analysis of network condition, without using any corresponding component/counter component, or without using any network proxy or management system, or any specific network architecture.

Another objective of the present invention is to provide a method and system that provides a gateway of all data paths from upper layers to a data-link, physical layer through IP and vice versa.

Another objective of the present invention is to provide a method and system that uses a predefined interne control message protocol (ICMP) echo packet for measuring the network channel condition.

Another objective of the present invention is to provide a method and system for enhancing the bandwidth of a system significantly by adding up the available bandwidth of the existing active communication interfaces.

Another objective of the present invention is to provide a method and system for estimating the channel/network condition associated with each active physical interface.

Yet another objective of the invention is to provide a method and system for bandwidth aggregation that can be used for any transport layer protocol like TCP (transport control protocol) or UDP (user datagram protocol).

Yet another objective of the invention is to provide a method and system that can be configured to operate in aggregation mode or aggregation combination with estimation mode.

Still another objective of the invention is to provide a method and system for enabling the analysis for the transport header (TCP) statistic for performing bandwidth estimation.

### SUMMARY OF THE INVENTION

Before the present methods, systems, and hardware enablement are described, it is to be understood that this invention in not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

The present invention provides a cross layer system which can perform bandwidth aggregation based on dynamic analysis of network condition.

In one aspect of the invention a method and system is provided for providing a gateway of all data paths from upper layers to a data-link, physical layer through IP and vice versa.

In another aspect of the invention a method and system is provided that enhances the bandwidth of a system significantly by adding up the available bandwidth of the existing active communication interfaces.

In another aspect of the invention a method and system is provided that uses a predefined internet control message protocol (ICMP) echo packet for measuring the network channel condition.

In another aspect of the invention channel/network condition associated with each active physical interface are estimated.

Another aspect of the invention is to provide a bandwidth aggregation and estimation methods and system which can be used for any transport layer protocol like TCP (transport control protocol) or UDP (user datagram protocol).

Still another aspect of the invention is to provide a method and system for analysis the transport header (TCP) statistics to perform the bandwidth estimation.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings a few exemplary constructions of the invention; however, it is to be understood that the invention is not limited to the specific methods and system disclosed in the drawings.

FIG. 1 is a flow diagram depicting method for aggregating and estimating the available bandwidth of multiple physical interfaces.

FIG. 2 is a flow diagram that illustrates functional blocks of bandwidth aggregation system.

### DETAILED DESCRIPTION OF THE INVENTION

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described. The disclosed embodiments are merely exemplary of the invention, which may be embodied in various forms.

Generally, the present invention relates to field of telecommunications. Particularly, this invention relates to a cross layer system which can perform bandwidth aggregation based on dynamic analysis of network condition.

The present invention provides a system for aggregating and estimating the bandwidth of the multiple physical interfaces, wherein the said system comprises:
a) one network driver module for aggregating and estimating the bandwidth of the multiple physical interfaces;
b) a user space of the network driver module for receiving the user defined input; and
c) physical interface connected with the network driver module for data transmission & estimation; and
d) at least two physical interfaces connected with the network driver module for aggregating, as well as estimating their bandwidths.

The present invention also provides a method for aggregating and estimating the available bandwidth of multiple physical interfaces using a network driver module, wherein the said method comprises the processor implemented steps of:
a) creating a virtual physical interface for encapsulating at least one existing physical interface;
b) enhancing the bandwidth by adding up available bandwidth of the active physical interfaces;
c) estimating the available bandwidth of each of physical interfaces dynamically at predefined time intervals;
d) estimating the network channel condition of existing physical interfaces by the network driver module; and
e) distributing the data packets to multiple physical interfaces based on the estimated network channel condition by the network driver module.

According to one of the embodiments, the present invention enables data over physical layer to communicate over both wireless and wired communication medium.

The present invention finds utility in wireless communication field and may be used to transfer data over short distances or long distances. It encompasses use of any type of fixed, mobile, and portable two-way radios, cellular telephones, personal digital assistants (PDAs), and wireless networking.

The present invention also finds utility in wired communication field and may be used for the transmission and reception of data over a wire-based communication technology. Examples include telephone networks, cable television or internet access, and fiber-optic communication.

According to one of the preferred embodiments of the invention the proposed cross layer system enhances the download and upload data transmission rates of application due to increase in bandwidth aggregation and thus enhances the QoS (quality of services).

In one embodiment the network drive module creates a ‘virtual physical’ interface which encapsulates all existing active physical interface present in the computing system. The said system thus does not perform any modifications in the physical and data-link layer of existing physical interface.

In one embodiment of the invention the network drive module provides a single communication pipe for flow of data from internet protocol (IP) to physical interface. The module also provides reception and transmission of the data to the various layers.

In one embodiment of the invention the network drive module enhances the bandwidth of system significantly by adding up available bandwidths of the existing active communication interfaces. The said system further comprises probe packet mechanism to estimate the channel condition of the active physical interfaces.

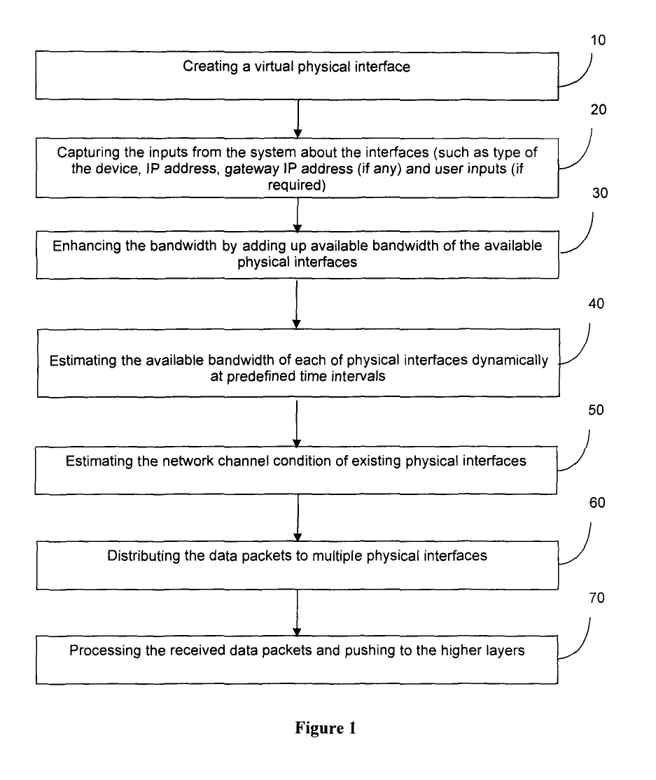

FIG. 1 depicts a flow diagram for aggregating and estimating the available bandwidth of multiple physical interfaces according to one exemplary embodiment of the invention. The process starts at the step 10 wherein a virtual physical interface is created for encapsulating at least one existing physical interface by a network driver module. At the step 20, system inputs are captured and user defined inputs are taken if require. At the step 30, bandwidth is enhanced by adding up available bandwidths of the multiple physical interfaces. At the step 40, the available bandwidth of each of physical interface is estimated dynamically at predefined time intervals. At the step 50, the network channel condition of existing physical interfaces is estimated by the network driver module. At the step 60, wherein the data packets are distributed to multiple physical interfaces based on the estimated network channel condition by the network driver module. The process ends at the step 70, upon reception the packets are processed by this module and pushed to the higher layers, wherein the network driver module uses packet filtering (net filter) mechanism and associates a hook function for processing the received packets. The hook function is used to filter the packets just after their reception by the active interfaces. The associated hook function of the packet-filter performs the necessary modifications in the data packets, and assembles the data packet before sending to the application.

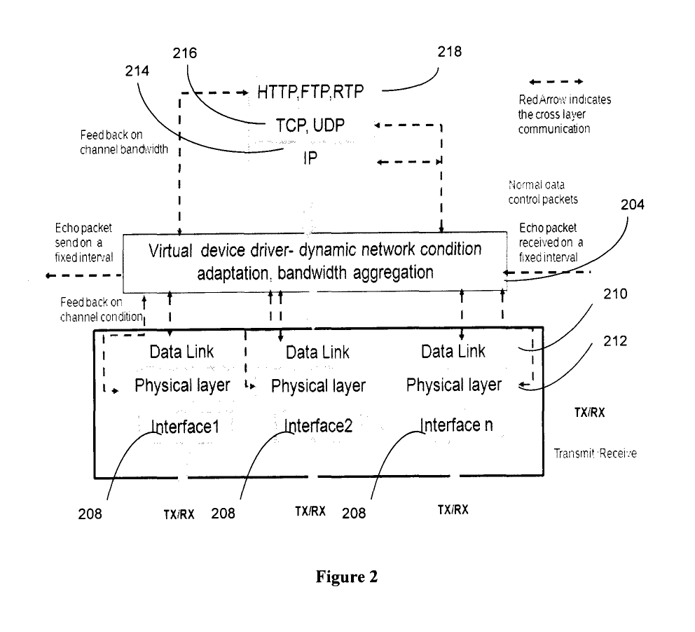

FIG. 2 illustrates a system architecture diagram for functional blocks of bandwidth aggregation system. The said system comprises a network driver module 204, a physical interface 208, data link 210, physical layer 212, Internet Protocol (IP) 214, transport protocol header 216, and port number 218.

The system further comprises, a user space 206 (not shown in figure), and a kernel space 207 (not shown in figure).

According to one of the preferred embodiments of the invention, the said user space 206 exposes APIs (application programming interfaces) to gather the user defined inputs, as well as system captured inputs. The said user defined inputs comprise;
a. Domain name of the server with a public IP address to which the probe packets are to be sent for estimation of available bandwidth of the network interfaces.
b. Time interval for performing network estimation
c. QoS requirement of an application (optional)
d. Other optional parameters (like enabling or disabling network estimation)

The user inputs are provided by the user through command line.

The said system defined inputs comprise;
a. Information about the network interfaces (interface identifier, IP addresses, IP address of gateways if any) available for bandwidth aggregation and estimation. System captured inputs are obtained by doing an ioctl( ) function call with a datagram socket.
b. Information about the status of the virtual physical interfaces/device (i.e. interface is UP, or DOWN, or any change in interface/device status) is also obtained.

In another embodiment of the invention the kernel space 207 acts as a bridge between applications and the actual data processing. The user space 206 and kernel space 208 have a close bonding and both these components exchange control information by using ioctl ( ) function call with a raw socket such as:
a. GETINFO: to collect information available with kernel space module about the network interfaces for aggregation.
b. SETINFO: to pass the information about the available network interfaces to the kernel space module.
c. NDMINFO (Network Diagnostics): to pass information related to bandwidth estimation to the kernel space module and also to collect the information about the available bandwidth of the network interfaces from the kernel space module.

In another embodiment of the invention the said system acts as a gateway of all the data paths from Internet protocol IP 214 (internet protocol) to the physical layer 212, starting from applications/upper layers and vice-versa. It distributes the data while transmitting among the existing active physical interfaces 208 based on the quality of services (QoS) requirement as specified by the application or by using the default configuration. It receives the data from the respective interfaces 208 and passes to the respective applications.

In another embodiment of the invention the network driver module 204 creates a virtual interface and assigns an IP address, netmask to it and adds this interface as the as default entry in the routing table. All the application data that comes from upper layer uses this IP address as the source address.

In another embodiment of the invention the network driver module 204 replaces its own IP address with the corresponding active physical interfaces 208′ IP addresses while distributing the data to those interfaces and performs the necessary checksum calculations for internet protocol IP 214 and transport protocols headers 216 as required. During reception it replaces the actual IP addresses of those interfaces with its own IP address and performs the necessary checksum calculations for internet protocol IP 214 and transport protocols headers 216.

In another embodiment of the invention the network driver module 204 uses the active interfaces/devices as its slave network interfaces. It distributes the data packets from application based on some predefined identifiers for example port number 218 (HTTP packet or FTP packet etc.) and quality of services' QoS requirement as specified by the application (optional) through its user space module 206. It sends the distributed data packets directly to the transmit queue of its slave interfaces i.e. the active physical interface 208. It uses packet filtering (net filter) mechanism and associates a hook function for this purpose in the receive path. The hook function is used to filter the packets just after their reception by the active interfaces. The associated hook function of the packet-filter performs the necessary modifications in the data packets, and assembles the data packet before sending to the application.

In another embodiment of the invention the proposed system uses a predefined internet control message protocol (ICMP) echo packet 222 for measuring the network channel condition. The interne control message protocol (ICMP) echo packet is sent to any public IP address (for example—www.google.com) defined by user simultaneously through the existing multiple active interfaces. The destination with the public IP address sends back the echo-reply to active physical interface 208. The Proposed system determines the time differences between the sent ICMP echo and received ICMP echo-reply packets i.e., the round trip time (RTT) for the active interfaces and estimates the network condition. The time difference with a higher value signifies a poor network condition. The system maintains a timer which makes an echo packet to be sent at a fixed time interval (configurable).

In another embodiment of the invention the proposed system also analyses the transport header 216 (TCP) statistics and takes the average RTTs obtained from both the transport header 216 and ICMP probe packet.

In still another embodiment of the invention the cross layer aware bandwidth aggregation system as presented here, can enhance the bandwidth of a system significantly by adding up the available bandwidths of the existing active communication interfaces (wired and wireless) by the network driver module 204 without performing any modifications in the physical layer 212 and data link layer 210 of the existing interfaces. At the same time it estimates the channel/network condition associated with each active physical interfaces 208. The system does not need any counterpart or corresponding module in any node including the final destination or end system of the communication link. It can be used for any transport layer protocol 216 like TCP (transmission control protocol) and UDP (user datagram protocol). Importantly, it does not require any service level agreement and a proxy support. It can perform an adaptive bandwidth aggregation.

The preceding description has been presented with reference to various embodiments of the invention. Persons skilled in the art and technology to which this invention pertains will appreciate that alterations and changes in the described structures and methods of operation can be practiced without meaningfully departing from the principle, spirit and scope of this invention.

### ADVANTAGES OF THE INVENTION

1) The present invention does not require any counter component, or corresponding module at the destination or end system to perform bandwidth aggregation and estimation—therefore it is easy to deploy, manage and at the same time cost effective.
2) The present invention provides a method and system which does not require any proxy to perform bandwidth aggregation and estimation.
3) The present invention provides a method and system wherein aggregation is done based on the bandwidth estimation, i.e. this invents a method of adaptive bandwidth aggregation.
4) The present invention provides a method and system which enhances the download and uploads data transmission rates of the application and hence enhances the QoS (quality of service).
5) The present invention does not require any service level agreement and a proxy support and it can perform an adaptive bandwidth aggregation by using multiple physical interfaces.

1) A method for aggregating and estimating the available bandwidth of multiple physical interfaces using a network driver module, wherein the said method comprises the processor implemented steps of:
a) creating a virtual physical interface for encapsulating at least one existing physical interface;
b) enhancing the bandwidth by adding up available bandwidths of the active multiple physical interfaces;
c) estimating the available bandwidth of each of physical interface dynamically at predefined time intervals;
d) estimating the network channel condition of existing physical interfaces; and
e) distributing the data packets to multiple physical interfaces based on the estimated network channel condition.

2) A method as claimed in claim 1, wherein the network driver module estimates the network channel condition for bandwidth aggregation using a probe packet mechanism.

3) A method as claimed in claim 1, wherein the network driver module measures the network channel condition by using a predefined interne control message protocol echo packet.

4) A method as claimed in claim 1, wherein the network driver module creates a virtual physical interface and the created virtual physical resides as the only default entry in the routing table.

5) A method as claimed in claim 1, wherein the network driver module replaces own IP address with IP address of the corresponding active interface for transmission of the data to the interface.

6) A method as claimed in claim 1, wherein the network driver module replaces IP address of the corresponding active interface with its own IP address for sending the data to the application.

7) A method as claimed in claim 1, wherein the said method enables the analysis for the transport header statistic to perform the bandwidth estimation.

8) A method as claimed in claim 1, wherein the said method can be configured to operate in aggregation mode or in aggregation combination with estimation mode.

9) A method as claimed in claim 1, wherein the said method characterized in that it does not require any proxy to perform bandwidth aggregation and estimation.

10) A method as claimed in claim 1, wherein the said method characterized in that it does not require any counter component, or corresponding module at the destination or end system.

11) A method as claimed in claim 1, wherein the said method characterized in that it does not require any service level agreement.

12) A system for aggregating and estimating the bandwidth of the multiple physical interfaces, wherein the said system comprises:
a) at least one network driver module for aggregating and estimating the bandwidth of the multiple physical interfaces;
b) a user space of the network driver module for receiving the user defined input;
c) physical interface connected with the network driver module for data transmission and estimation; and
d) at least two physical interfaces connected with the network driver module for aggregating and estimating their bandwidths.

13) A system as claimed in claim 12, wherein the network driver module replaces own IP address with IP address of the corresponding active interface for transmission of the data to the interface.

14) A system as claimed in claim 12, wherein the network driver module replaces IP address of the corresponding active interface with its own IP address for sending the data to the application layer.

15) A system as claimed in claim 12, wherein the network driver module estimates the network channel condition for bandwidth aggregation by using a probe packet mechanism.

16) A system as claimed in claim 12, wherein the network driver module measures the network channel condition by using a predefined interne control message protocol echo packet.

17) A system as claimed in claim 12, wherein the said system enables the analysis for the transport header statistic to perform the bandwidth estimation.

18) A system as claimed in claim 12, the said system takes the average of Round Trip Time (RTTs) obtained from both ICMP echo packet and transport header statistics to perform the network estimation.
